(19) United States
(12) Patent Application Publication
(10) Pub. No.: US 2026/0281155 A1
(43) Pub. Date: Sep. 17, 2026

(54) DETECTING PROTOCOL IMPERSONATION WITH NETWORK INTELLIGENCE

(71) Applicant: Cisco Technology, Inc., San Jose, CA (US)

(72) Inventors: Blake Harrell Anderson, Chapel Hill, NC (US); Apoorv Raj, Nagpur (IN); David Arthur McGrew, Poolesville, MD (US); Prateek Somani, Mandsaur (IN)

(21) Appl. No.: 19/082,083

(22) Filed: Mar. 17, 2025

(51) Int. Cl. H04L 9/40

(52) U.S. Cl. CPC H04L 63/1483

(57) ABSTRACT

Adversaries can use evasive software or techniques to evade detection by network tools, resulting in vulnerabilities to the network. The described techniques provide a detection system that can be implemented by a cloud service provider and a network device. The detection system provides processes for detecting protocol impersonation on the initial data packets of a network connection, which allows the system to enforce network policies before the network connection is established. The techniques look for protocol inconsistencies in the initial data packet and/or initial data packets. Accordingly, the techniques may provide a more accurate and less resource intensive way to perform in-line detection of protocol impersonation, thereby reducing the number of false positives reported and improving security of the network.

### TECHNICAL FIELD

The present disclosure relates generally to the field of computer networking, and more particularly to detecting protocol impersonation and domain faking in networks.

### BACKGROUND

Malicious actors (e.g., adversaries) may utilize evasive techniques to avoid network-based detection and/or network firewalls and thereby gain access to a network. An example technique may include protocol impersonation. For instance, an adversary may impersonate legitimate protocols or web service traffic to disguise command and control (C2) activity and thwart analysis efforts. By impersonating legitimate protocols or web services, the adversary can make their C2 traffic blend in with legitimate network traffic. The adversary may also impersonate secure sockets layer (SSL)/ transport layer security (TLS) handshakes to make it look like subsequent traffic is SSL/TLS encrypted, potentially interfering with some security tooling, or to make the traffic look like it is related with a trusted entity. Further, adversaries may leverage legitimate protocols to impersonate expected web traffic or trusted services. For example, adversaries may manipulate hypertext protocol (HTTP) headers, uniform resource identifier (URI) endpoints, SSL certificates, and transmitted data to disguise C2 communications or mimic legitimate services.

Accordingly, there is a need for a way to intelligently detect protocol impersonation within a network.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a system can detect protocol impersonation, as described herein.

FIG. 2 illustrates a component diagram of an example detection system, according to the techniques described herein.

FIG. 3A illustrates an example system for leveraging global infrastructure, according to the techniques described herein.

FIG. 3B illustrates an example process for vetting mapping data collected by the system of FIG. 3A, according to the techniques described herein.

FIG. 4 illustrates a flow diagram of an example method for detecting protocol impersonation and domain faking, according to the techniques described herein.

FIG. 5 illustrates a flow diagram of an example method for detecting protocol impersonation, according to the techniques described herein.

FIG. 6 is a computer architecture diagram showing an illustrative computer hardware architecture for implementing a device that can be utilized to implement aspects of the various technologies presented herein.

### DESCRIPTION OF EXAMPLE EMBODIMENTS

### Overview

The present disclosure relates generally to the field of computer networking, and more particularly to detecting protocol impersonation and domain faking with a network.

A method to perform the techniques described herein may receiving, from a client device, a first data packet associated with establishing a session between the client device and a server. Th method may include determining, based on data included in the first data packet, a server name and an address of the server. The method further includes determining that the server name is associated with evasive software that supports protocol impersonation or domain faking. The method may include determining that an expected domain name matches the address. The method also includes based on determining that the expected domain name does not match the server name, performing an action.

Another method to perform the techniques to detect protocol impersonation. The method may include receiving a first data packet and a second data packet associated with establishing a session between a client device and a server. The method may include determining that the first data packet comprises first data associated with a request from the client device. The method further includes determining that the second data packet comprises second data associated with a response from the server. The method also includes determining, based on the first data, cipher suite data and extension data associated with the client device. The method may include determining, based on the cipher suite data, the extension data, and second data, one or more protocol inconsistencies. The method also includes performing, based on the one or more protocol inconsistencies, an action.

Additionally, any techniques described herein, may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### Example Embodiments

Malicious actors may utilize evasive techniques to avoid network-based detection and/or network firewalls and thereby gain access to a network. An example technique may include protocol impersonation. For instance, an adversary may impersonate legitimate protocols or web service traffic to disguise command and control (C2) activity and thwart analysis efforts. By impersonating legitimate protocols or web services, the adversary can make their C2 traffic blend in with legitimate network traffic. The adversary may also impersonate secure sockets layer (SSL)/ transport layer security (TLS) handshakes to make it look like subsequent traffic is SSL/TLS encrypted, potentially interfering with some security tooling, or to make the traffic look like it is related with a trusted entity. Further, adversaries may leverage legitimate protocols to impersonate expected web traffic or trusted services. For example, adversaries may manipulate hypertext protocol (HTTP) headers, uniform resource identifier (URI) endpoints, SSL certificates, and transmitted data to disguise C2 communications or mimic legitimate services.

For instance, to evade network-based detection, adversaries may use a protocol impersonation technique, such as the MITRE ATT&CK technique, which allows C2 traffic to mimic popular network protocols connecting to trusted web services. The most common form of protocol impersonation evasion is FakeTLS, where the evasive (or malicious) application running on the client device will set the TLS server_name value to a benign or prevalent domain name and the malicious server will replay a benign/prevalent certificate. For instance, the evasive application may construct bytes that resemble a TLS data packet, such that the FakeTLS packet will bypass network enforcement tools. As an example, network firewalls may enforce policies on TLS sessions by looking at by looking at the server name extension or the certificate, which describes the identity of the server the client is trying to communicate with. However, in the case of FakeTLS, the FakeTLS packet will include a server name that is well known (e.g., Google. com, etc.) even though the client device is not actually communicating with Google servers. Thus, protocol impersonation and FakeTLS can successfully evade the domain name-based policies and controls. For example, if a decryption policy is naively based on the domains present in the TLS server_name and certificate subject, the adversary can use FakeTLS and set those values to a service that is commonly on a “Do Not Decrypt” list.

Current approaches for detecting protocol impersonation include using traditional IP address watchlists and/or attempting to decrypt the impersonated sessions. However, with IP address watchlists, you have to know the IP addresses of all of the evasive services. Given the IP addresses tend to change rapidly keeping the IP addresses in the watchlist up to date and accurate is extremely difficult. Moreover, decrypting impersonated sessions tends to result in a high number of false positives, given a packet that does not decrypt is marked as a FakeTLS. Further, both maintaining IP address watchlists and decrypting impersonated sessions can be costly, resource intensive, and difficult to scale.

Accordingly, there is a need for a way to intelligently detect protocol impersonation within a network. For instance, there is a need for a way to detect protocol impersonation for communication(s) where a client is communicating with a malicious (and/or evasive) domain or server.

This disclosure describes techniques and mechanisms for a system to detect protocol impersonation and domain faking in a network, prior to an encrypted session being formed. In some examples, the system may receive, from a client device, a first data packet associated with establishing a session between the client device and a server. The system may determine, based on data included in the first data packet, a server name and an address of the server. The system may determine that the server name is associated with evasive software that supports protocol impersonation or domain faking. The system may also, determining that an expected domain name matches the address. The system may further, based on determining that the expected domain name does not match the server name, perform an action.

In another example, the system may perform techniques to detect protocol impersonation using initial data packet(s) to establish an encrypted session. The techniques may include receiving a first data packet and a second data packet associated with establishing a session between a client device and a server. The system may determine that the first data packet comprises first data associated with a request from the client device. The system may determine that the second data packet comprises second data associated with a response from the server. The system further determines, based on the first data, cipher suite data and extension data associated with the client device. The system also determines, based on the cipher suite data, the extension data, and second data, one or more protocol inconsistencies. The system may performs, based on the one or more protocol inconsistencies, an action.

In some examples, the first data packet(s) may comprise TLS client_hello data packet(s) that are sent by a client device and the second data packet(s) may comprise TLS server_hello data packet(s) sent by a server. In some examples, the client_hello may comprise first data including a list of one or more cipher suites that define types of cryptography the client device supports or prefers to use to encrypt the connection. The first data may further comprise a set of extensions that the client device and/or server need to establish a connection. The server_hello may comprise second data comprising the selected cipher suites for use in encrypting the connection and/or second extension(s).

In some examples, the techniques of the system may be implemented by a detection system. The detection system may be implemented by a cloud service provider (e.g., such as Cisco) and/or on network device(s) of the cloud service provider. In some examples, the detection system may be included as part of a firewall service (e.g., such as Cisco's Secure Firepower) that may be implemented at a cloud service provider and/or network device(s).

In some examples, the system may comprise a pattern component. The pattern component may be configured to receive and/or monitor first data packet(s) from a client device and second data packet(s) from a server. In an example, the pattern component is configured to access and store data from third party servers. For instance, the pattern component may retrieve data from the internet assigned numbers authority (IANA) and store the data in memory and/or a database of the system.

The pattern component may be configured to identify protocol inconsistencies between data included in the first data packet(s) and the second data packet(s) (e.g., TLS client_hello and server_hello). Accordingly, the pattern component may determine, based on the first data and the second data, whether there is anything in the second data that is inconsistent with the first data. For instance, the pattern component may identify a FakeTLS based on identifying one or more inconsistencies that should result in a TLS error when establishing the connection (e.g., during the TLS handshake) and determining that the system did not observe the TLS error. In an example, the inconsistencies may include, but are not limited to: one or more of selected cipher suites in the second data are not recognized by IANA and there is no TLS error; the selected cipher suite in the second data does not appear in the offered cipher suite list of the first data; extension data included in the second data is not recognized by IANA; if the random nonce contains a timestamp, that timestamp is not accurate; protocol required extensions are absent; and/or there is inconsistency between the parameters offered in client extensions (e.g., supported groups, etc.) versus the parameters chosen in the server extensions.

Accordingly, the pattern component may leverage programming of evasive applications or software to identify data inconsistencies that do not make sense in the context of establishing a valid TLS session.

In some examples, the system may comprise an intelligence component. The intelligence component may be configured to collect, mine, and generate mappings between IP addresses and domain names.

In an example, such as where the intelligence component is implemented by a cloud service provider, the intelligence component may receive data from a plurality of collection sites around the world that passively collect and process DNS responses. Each collection site may comprise one or more DNS resolvers configured to passively monitor DNS traffic. The intelligence component may be configured to generate mappings between IP addresses of client device(s) and domain names. Further, in order to avoid false positives due to the rotation of addresses within a subnet, the system does not rely only on the destination address of a packet. Instead, the system may store a set of subnets associated with a domain name, and those subnets are mapped based on intelligence about the owner and operator of the domain name. Accordingly, each mapping may indicate a domain name and set(s) of IP addresses that all appear within a subnet, or a small number of subnets, of one or more autonomous system(s). The set(s) of IP addresses correspond to “good” addresses (e.g., addresses that are not associated with evasive software, applications, endpoints, etc., are secure, and/or have been validated by the system, etc.). Thus, instead of maintaining watch lists of destination IP addresses associated with malicious and/or evasive behavior, the system described herein may build mappings between domains and legitimate source IP addresses.

In some examples, the intelligence component may be configured to compile, based on the collected data, a list of mappings that include domain names that are frequently used in FakeTLS/protocol impersonation attacks and associated IP addresses. The intelligence component may send the list to network device(s) within the network for use in real-time detection. Thus, the system may create a subset of mappings that include domain name/IP address datasets of the most frequently used domain names that can be sent to the network devices. Accordingly, the system may reduce computational resources and memory used by the network devices to store and maintain the lists, while providing the greatest coverage of domains targeted for domain impersonation. In some examples, the intelligence component may be configured to update the list(s) sent to the network devices in real-time (e.g., by streaming and/or in response to changes in the mappings) and/or based on a pre-determined time interval (e.g., daily, weekly, etc.).

In some examples, the system may comprise an address component. The address component may be configured to detect protocol impersonation by identifying inconsistencies between the destination IP address and the value contained in the TLS server_name extension. For instance, the address component may, in response to identifying a first data packet as a TLS client_hello, determine whether there is data indicating the domain_name is associated with evasive techniques. If the system determines that there is intelligence indicating the domain name is associated with evasive techniques, the address component may use a longest-prefix match algorithm on the destination address, and if a subnet is found, compare the associated domain name with the server name stored in the server name field. If there is a mismatch, the address component may determine that FakeTLS has been identified.

In some examples, the system may comprise an action component. The action component may be configured to perform an action in response to detecting protocol impersonation. For instance, the action may comprise blocking a connection, generating an alert, sending a log message, generating and adding an attribute to a network map that identifies evasive software as running on a particular endpoint, maintaining a cache of IP addresses and domain(s) that have been identified as FakeTLS but are not included in memory of the system, updating the memory of the system, requesting a look-up service, etc.

In some examples, the system may be configured to leverage a global infrastructure. For instance, the system may be implemented by a cloud service provider. In this example, the system may additionally or alternatively comprise a verification component and/or a look up service. In some examples, the verification component and/or look up service may be included as part of the firewall service.

In some examples, the system may comprise a verification component. The verification component may be configured to process the collected mappings to reduce false positives. For instance, the verification component may be configured to vet the collected data from the collection site(s) prior to the system generating the mappings. For instance, as described in greater detail below, the verification component may be configured to initially determine whether data packet(s) associated with a connection include a proxy. Where there is no proxy, the verification component may perform techniques described herein to identify protocol impersonation. Where the verification component identifies a proxy connection and/or determines the data packet(s) are not the client_hello and/or server_hello packets, the process may be skipped.

The look up service may be configured to perform real-time look ups of domain name(s) and/or address(es) received from a network device. For instance, a particular server name may be associated with evasive software but not included in the list stored on the network device. The network device may, in real-time, send a request to the look up service to determine whether the addresses are associated with the domain and/or whether the connection is associated with FakeTLS.

In this way, the system may provide an intelligent way to enforce network policies and detect protocol impersonation before a session is established. By utilizing and mapping IP addresses of the “good” (e.g., valid) services associated with a domain, the techniques described herein are more stable and reliable. For instance, the techniques described herein may be applied to TLS client_hello packets in a passive manner, reducing resources required by the system (e.g., in contrast, with decryption, were you have to actively establish connection, which is computationally more intensive). Further, by utilizing the global infrastructure to identify and map IP addresses to the domain(s), the techniques described herein provide improved accuracy at identifying protocol impersonation and provide fewer false positives than existing techniques. Thus, the techniques may improve network security by preventing evasive techniques from bypassing network enforcement tools within a network.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

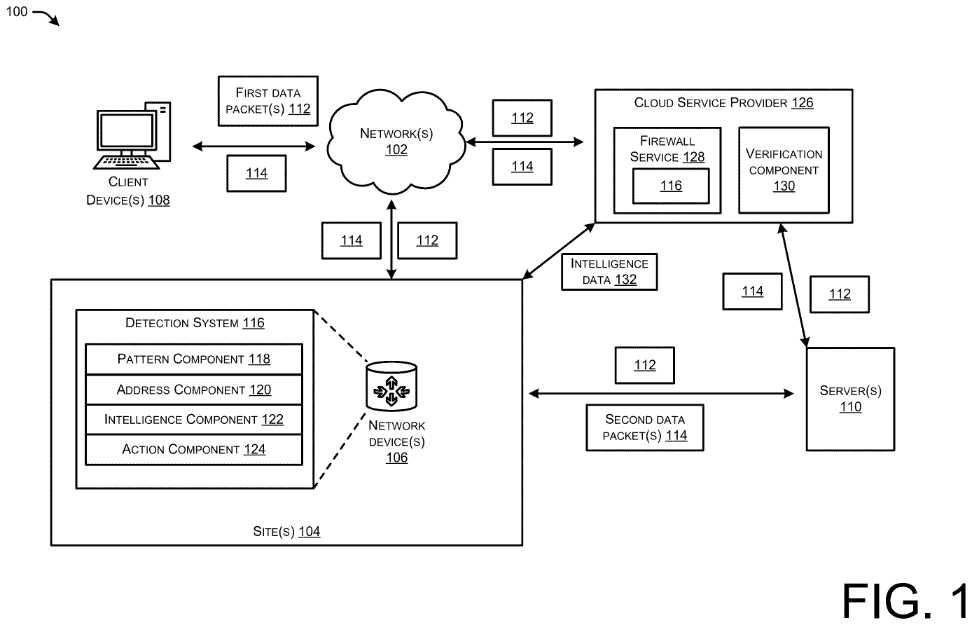

FIG. 1 illustrates a system-architecture diagram of an environment in which a system 100 detect protocol impersonation, as described herein. While the system 100 shows an example detection system 116 being implemented by a firewall service 128, it is understood that any of the components of the system 100 may be implemented on any device in the network 102. Further, while the system 100 is described in relation to TLS protocol and using TLS client_hello and/or TLS server_hello data packets, it is understood that the techniques may be applied to any suitable protocol or system in order to detect protocol impersonation within the network. For instance, the system 100 may be applied to certificates or other security features of data packets.

In some examples, the system 100 may include network(s) 102. The network(s) 102 may include one or more networks implemented by any viable communication technology, such as wired and/or wireless modalities and/or technologies. The network(s) 102 may include any combination of a service network, Personal Area Networks (PANs), SDCI, Local Area Networks (LANs), virtual LANs, Campus Area Networks (CANs), Metropolitan Area Networks (MANs), extranets, intranets, the Internet, short-range wireless communication networks (e.g., ZigBee, Bluetooth, etc.), RA VPNs, VPNs, ZTNA, Wide Area Networks (WANs)-both centralized and/or distributed-and/or any combination, permutation, and/or aggregation thereof. The network(s) 102 may include devices, virtual resources, or other nodes that relay packets from one network segment to another by nodes in the computer network. The network(s) 102 may include multiple devices that utilize the network layer (and/or session layer, transport layer, etc.) in the OSI model for packet forwarding, and/or other layers.

The system 100 may comprise site(s) 104. In some examples, the site(s) 104 comprise one or more server(s), enterprise network(s) and/or service(s) associated with a service provider (e.g., such as cloud service provider 126), one or more network device(s) 106, etc. In some examples, the site(s) 104 correspond to one or more data center(s) comprising various network components, such as, for example, network switch(es) (also referred to as node(s)) operating on physical servers. In some examples, the site(s) 104 may comprise physical server(s) that may host one or more virtual machines. Each virtual machine may be configured to execute one of various operations and act as one or more virtual components for the cloud network(s) and/or enterprise/application network, such as, for example, application(s). In some examples, the physical server(s) may host any number of virtual machines. In some examples, the physical server(s) in the enterprise/application network may host the various network components of the enterprise/application network. In some examples, the client device(s) 108 comprise one or more user(s), mobile device(s), and/or Internet of Things (IOT) device(s) located at one or more locations.

The system 100 may comprise one or more network device(s) 106. For instance, as noted above the detection system 116 may monitor network data and/or session data (e.g., network traffic load data, network client data, etc.) or other data (e.g., application load data, data and/or metadata associated with WLCs, APs, etc.) via the network device(s) 106 that is associated with one or more session(s) of a user of the device(s) 108. The network device(s) 106 may comprise routers, switches, access points, stations, radios, or any other network device. In some examples, the network device(s) 106 may monitor traffic flow(s) within the network and may report information associated with the traffic flow(s) to the cloud service provider 126.

The system 100 may comprise client device(s) 108 and server(s) 110. In some examples, device(s) 108 may be configured to send first data packet(s) 112 that are encoded according to a particular protocol. The client device(s) 108 may correspond to a computing device of a client and may comprise one or more IP address(es). Server(s) 110 may comprise endpoint(s) and/or service(s) that the client device(s) 108 want to communicate with. For instance, client device(s) 108 may be configured to communicate with server(s) 110 via network(s) 102, site(s) 104, and/or cloud service provider 126. In some examples, the client device(s) 108 and server(s) 110 may communicate according to one or more protocols. Server(s) 110 may comprise any service, cloud, application, website, server, device, etc. and may be included as part of the site(s) 104 and/or may be external to the site(s) 104.

For instance, the client device(s) 108 may establish and/or attempt to establish session(s) with the server(s) 110 using an encrypted protocol (e.g., such as TLS or any other suitable protocol). The client device(s) 108 may be configured to send first data packet(s) 112 to the server(s) 110 via network(s) 102. The server(s) 110 may be configured to send second data packet(s) 114 to the client device(s) 108 via network(s) 102. In some examples, the first data packet(s) 112 and/or second data packet(s) 114 may be monitored by and/or routed through network device(s) 106 and/or cloud service provider 126. For instance, the first data packet(s) 112 may be sent from client device(s) 108 to the network device(s) 106 and/or cloud service provider 126 via network(s) 102. The network device(s) 106 and/or cloud service provider 126 may pass the first data packet(s) 112 through a firewall service 128 and/or detection system 116 before the first data packet(s) 112 reach server(s) 110. The second data packet(s) 114 may be sent from server(s) 110 to the network device(s) 106 and/or cloud service provider 126 via network(s) 102. The network device(s) 106 and/or cloud service provider 126 may pass the second data packet(s) 114 through a firewall service 128 and/or detection system 116 before the second data packet(s) 114 reach client device(s) 108.

In some examples, the first data packet(s) 112 may comprise TLS client_hello data packet(s). The first data packet(s) 112 may be sent in order to establish a connection (e.g., such as a TLS session) between a client device 108 and a server 110. The first data packet(s) 112 may comprise first data including cipher suite data, extension data, etc. The second data packet(s) 114 may comprise TLS server_hello data packet(s). The second data packet(s) 114 may comprise second data including extension data, selected cipher suite data, etc.

The system 100 may comprise a detection system 116. In some examples, the detection system 116 may be integrated as part of a firewall service 128 running on a cloud service provider 126 (e.g., such as Cisco) and/or network device(s) 106. For instance, the firewall service 128 may correspond to Cisco's Secure Firewall Service.

In some examples, the detection system 116 may be implemented on one or more network device(s) 106 and/or at the cloud service provider 126. The detection system 116 may correspond to a system that has complete visibility into the fabric of a given network (e.g., enterprise network, local network, etc.) and may be configured to monitor traffic flow within the network(s) 102. In an example, the detection system 116 may correspond to an engine (e.g., such as Cisco's Encrypted Visibility Engine) of the cloud service provider 126 that is configured to operate on initial data packet(s) of a network connection. In some examples, the detection system 116 may comprise a controller, one or more processors, etc. In some examples, the detection system 116 may be integrated as part of Cisco's Secure Firewall Service.

In some examples, the cloud service provider 126 is configured to provide cloud service(s) to the client device(s) 108. In some examples, the cloud service provider 126 comprises the firewall service 128, detection system 116, and/or a verification component 130. In an example, the verification component 130 may be implemented as part of detection system 116. As described in greater detail herein, the verification component may be configured to process collected mappings from DNS collection sites around the world, in order to reduce the number of false positives associated with protocol impersonation.

In some examples, the network device(s) 106 are configured to communicate with the cloud service provider 126. For instance, the network device(s) 106 may be configured to receive intelligence data 132 from the cloud service provider 126 and/or send intelligence data 132 to the cloud service provider 126. In some examples, the intelligence data 132 may comprise a subset of mapping(s) between domain(s) and corresponding address(es) (e.g., IP address(es) of client device(s)). In some examples, intelligence data 132 may be encrypted according to encryption techniques. In some examples, the intelligence data 132 may comprise indications of domain(s) and/or address(es) associated with evasive techniques. In some examples, the intelligence data 132 may comprise mapping(s) stored by the network device(s) 106 and associated with domain(s) and address(es) identified by the detection system 116 as protocol impersonation, but are not included in the subset of mapping(s). In an example, the intelligence data 132 may comprise an update to a network map and mapping data associated with a particular domain and address(es) identified as being FakeTLS. In some examples, the intelligence data 132 may be streamed and/or provided as an update on a periodic basis (e.g., hourly, daily, weekly, biweekly, etc.).

The detection system 116 may include a pattern component 118. The pattern component 118 may be configured to identify protocol inconsistencies between data included in the first data packet(s) and the second data packet(s) (e.g., TLS client_hello and server_hello). Accordingly, the pattern component 118 may determine, based on the first data and the second data, whether there is anything in the second data that is inconsistent with the first data. For instance, the pattern component 118 may determine a connection is FakeTLS based on identifying one or more inconsistencies that should result in a TLS error when establishing the connection (e.g., during the TLS handshake) and determining that the system did not observe the TLS error. In an example, the inconsistencies may include, but are not limited to: one or more of selected cipher suites in the second data are not recognized by IANA and there is no TLS error; the selected cipher suite in the second data does not appear in the offered cipher suite list of the first data; extension data included in the second data is not recognized by IANA; if the random nonce contains a timestamp, that timestamp is not accurate; protocol required extensions are absent; and/or there is inconsistency between the parameters offered in client extensions (e.g., supported groups, etc.) versus the parameters chosen in the server extensions.

Accordingly, the pattern component 118 may leverage programming of evasive applications or software to identify data inconsistencies that do not make sense in the context of establishing a valid TLS session.

The detection system 116 may include an address component 120. The address component 120 may be configured to detect protocol impersonation using the first data included in the first data packet(s) 112. For instance, the address component 120 may be configured to identify inconsistencies between a destination IP address and the value contained in the TLS server_name extension. For instance, the address component 120 may, in response to identifying a first data packet as a TLS client_hello, determine whether there is data indicating the domain_name is associated with evasive techniques. If the system determines that there is intelligence indicating the domain name is associated with evasive techniques, the address component may use a longest-prefix match algorithm on the destination address, and if a subnet is found, compare the associated domain name with the server name stored in the server name field. If there is a mismatch, the address component may determine that FakeTLS has been identified.

The detection system 116 may include an intelligence component 122. In some examples, the intelligence component 122 may be configured to compile mappings between domain(s) and address(es) into a format to be stored in a data structure at the cloud service provider 126 and/or network device(s) 106. The data structure may enable the system 100 to perform fast lookups of information. For instance, the data structure may comprise a LC-trie data structure or any other suitable data structure. The intelligence component 122 may be configured to convert the mapping(s) into a format and load the mapping(s) into the data structure in the memory of the network device(s).

In some examples, the intelligence component 122 may be configured to compile list(s) of mappings that include domain names that are frequently used in FakeTLS/protocol impersonation attacks and associated IP addresses. For instance, the intelligence component 122 may mine collected data to generate the list(s). Thus, the system 100 may create a subset of mappings that include domain name/IP address datasets of the most frequently used domain names that can be used by the network device(s) 106 and/or cloud service provider 126 for inline detection.

Accordingly, the system may reduce computational resources and memory used by the network devices to store and maintain the lists, while providing the greatest coverage of domains targeted for domain impersonation. In some examples, the intelligence component may be configured to update the list(s) sent to the network devices in real-time (e.g., by streaming and/or in response to changes in the mappings) and/or based on a pre-determined time interval (e.g., daily, weekly, etc.).

The detection system 116 may include an action component 124. The action component 124 may be configured to perform an action in response to detecting protocol impersonation. For instance, the action may comprise blocking a connection, generating an alert, sending a log message, generating and adding an attribute to a network map that identifies evasive software as running on a particular endpoint, maintaining a cache of IP addresses and domain(s) that have been identified as FakeTLS but are not included in memory of the system, updating the memory of the system, requesting a look-up service, etc. In some examples, the action component 124 is configured to update the network map in real-time (e.g., such as via intelligence data 132).

In some examples, the detection system 116 may be implemented by a network device. In this example, the detection system 116 may receive from a cloud service provider, intelligence data comprising mappings between a set of domains and IP addresses. The detection system may be configured to perform inline detection of protocol impersonation and domain faking. The detection system may be configured to load the intelligence data into a data structure in the memory of the network device (e.g., such as a LC-trie implementation) for efficient lookups. Upon receiving a TLS client_hello, the detection system may checks if it has FakeTLS intelligence for the server_name value included in the TLS client_hello. If the FakeTLS intelligence is found, the detection system may look up the expected domain name using the IP address included in the TLS client_hello as an input to the data structure. The data structure may provide an output comprising the expected domain name. If the expected domain name and the TLS server_name do not match, the detection system may perform an action (e.g., such as reporting a FakeTLS is detected, blocking the connection, generating an attribute for a network map, etc.).

In some examples, the detection system 116 may be implemented by a cloud service provider 126. In this example, the detection system may perform inline detection using the same logic as the network device, however, the cloud service provider may store a greater set of intelligence data, including a larger set of mappings.

In some examples, one or more of the functionalities of the detection system 116 may be performed in tandem with or independently of each other. For instance, the functionality of the pattern component 118 may be performed in parallel to and/or independently of the functionalities of the address component 120, intelligence component 122, and/or action component 124.

In this way, the system may provide an intelligent way to enforce network policies and detect protocol impersonation before a session is established. By utilizing and mapping IP addresses of the “good” (e.g., valid) services associated with a domain, the techniques described herein are more stable and reliable. For instance, the techniques described herein may be applied to TLS client_hello packets in a passive manner, reducing resources required by the system (e.g., in contrast, with decryption, were you have to actively establish connection, which is computationally more intensive). Further, by utilizing the global infrastructure to identify and map IP addresses to the domain(s), the techniques described herein provide improved accuracy at identifying protocol impersonation and provide fewer false positives than existing techniques. Thus, the techniques may improve network security by preventing evasive techniques from bypassing network enforcement tools within a network.

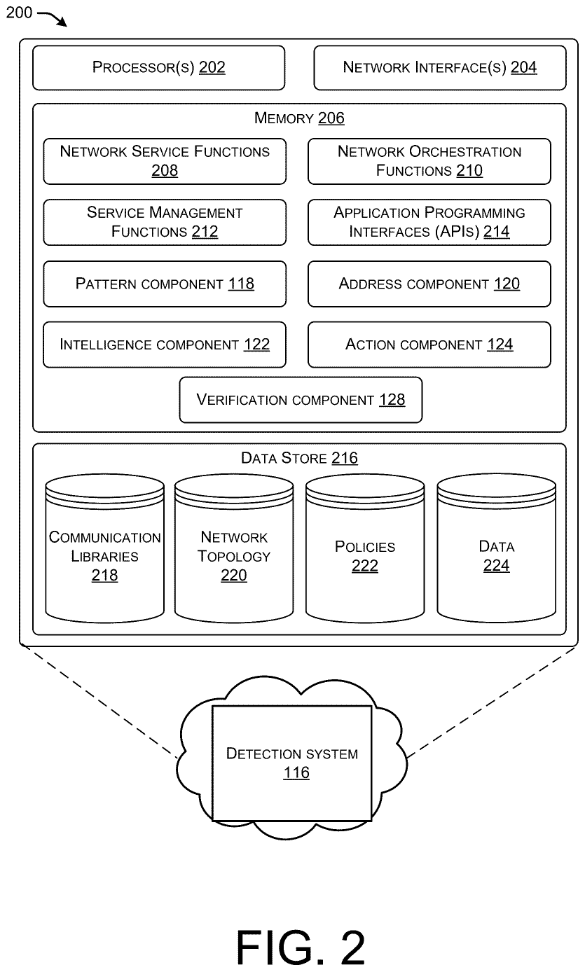

FIG. 2 illustrates a component diagram 200 of an example detection system, as described herein. In some instances, the detection system 116 may run on one or more computing devices in, or associated with, the network 102 (e.g., a single device or a system of devices). In some instances, the detection system 116 may be integrated as part of a firewall service 128 (e.g., such as Cisco's Secure Firewall Service). In some examples, the detection system 116 may be run on network device(s) 106 and/or as part of services offered by a cloud service provider 126. In some examples, one or more of the component(s) of the detection system 116 may be implemented by the network device(s) 106 and/or cloud service provider 126, however, fewer or additional components may also be used.

Generally, the detection system 116 may include a programmable controller that manages some or all of the controller activities of the network 102, and manages or monitors the network state using one or more centralized control models.

As illustrated, the detection system 116 may include, or run on, one or more hardware processors 202 (processors), one or more devices, configured to execute one or more stored instructions. The processor(s) 202 may comprise one or more cores. Further, the detection system 116 may include or be associated with (e.g., communicatively coupled to) one or more network interfaces 204 configured to provide communications with network device(s) 106, edge device(s) and other devices, and/or other systems or devices in the network 102 and/or remote from the network 102. The network interfaces 204 may include devices configured to couple to personal area networks (PANs), wired and wireless local area networks (LANs), wired and wireless wide area networks (WANs), SDCI's, and so forth. For example, the network interfaces 204 may include devices compatible with any networking protocol.

The detection system 116 may also include memory 206, such as computer-readable media, that stores various executable components (e.g., software-based components, firmware-based components, etc.). The memory 206 may generally store components to implement functionality described herein as being performed by the detection system 116. The memory 206 may store one or more network service functions 208, such as a slicing manager, a topology manager to manage a topology of the network 102, a host tracker to track what network components are hosting which programs or software, a switch manager to manage switches of the network 102, a process manager, and/or any other type of function performed by the detection system 116.

The detection system 116 may further include network orchestration functions 210 stored in memory 206 that perform various network functions, such as resource management, creating and managing network overlays, programmable APIs, provisioning or deploying applications, software, or code to hosts, and/or perform any other orchestration functions. Further, the memory 206 may store one or more service management functions 212 configured to manage the specific services of the network 102 (configurable), and one or more APIs 214 for communicating with devices in the network 102 and causing various controller functions to occur.

In some examples, the detection system 116 may include a pattern component 118. As described above the pattern component 118 may be configured to identify protocol inconsistencies between data included in the first data packet(s) and the second data packet(s) (e.g., TLS client_hello and server_hello). As an example, evasive applications (e.g., such as Potato VPN) may generate data packet(s) that mimic TLS data packet(s), but contain one or more non-conformities with TLS protocol. In this example, if the data packet(s) were valid (e.g., real) TLS data packets, the non-conformities should result in a TLS error occurring during the TLS handshake between a client and a server. However, where the data packet(s) are FakeTLS data packet(s), the TLS error may not be observed and/or occur. Accordingly, in this example, once the detection system 116 determines that the first data packet(s) comprise a TLS client_hello, the pattern component 118 may extract first data comprising list(s) of cipher suite data (e.g., defining the type(s) of cryptography the client prefer(s)) and extension data. The pattern component 118 may then access memory and/or a database of the detection system 116 that stores registry data (e.g., IANA data and/or other official registries). The pattern component 118 may extract and parse second data from second data packet(s) 114 comprising extension data selected by the server. The pattern component 118 may compare the first data, second data, and registry data to determine whether one or more inconsistencies exist that should result in a TLS error.

As an example, the second data may comprise a selected cipher suite, however, the selected cipher suite may not exist and/or may not be included in the first data. In this example, the pattern component 118 may determine that the TLS handshake observed by the detection system 116 was fake and may output an indication to the action component 124 to perform an action. In some examples, the indication may include data associated with the client device and the server (e.g., such as IP address(es) of the client, the domain, server name, etc.).

Accordingly, the pattern component 118 may leverage programming of evasive applications or software to identify data inconsistencies that do not make sense in the context of establishing a valid encrypted connection (e.g., such as TLS or any other suitable protocol).

The detection system 116 may include address component 120. As described herein, the address component 120 may be configured to perform a process to detect protocol impersonation by identifying inconsistencies between a destination IP address and the value contained in the TLS server_name extension field of a first data packet 112.

The detection system 116 may include intelligence component 122. As described herein, the map component 122 may be configured to collect, mine, and generate mappings between IP addresses and domain names. In some examples, the intelligence component 122 is configured to generate a list comprising a subset of mappings between IP address(es) of client device(s) and domain(s) that are known for evasive techniques. In some examples, the intelligence component 122 is configured to generate indications of domain(s) associated with use of evasive techniques in addition to the list of mapping(s).

The detection system 116 may include action component 124. As described herein, the action component may be configured to perform an action in response to detecting protocol impersonation. For instance, the action may comprise blocking a connection, generating an alert, sending a log message, generating and adding an attribute to a network map that identifies evasive software as running on a particular endpoint, maintaining a cache of IP addresses and domain(s) that have been identified as FakeTLS but are not included in memory of the system, updating the memory of the system, requesting a look-up service, etc.

In some examples, one or more of the pattern component 118, event component 120, map component 122, and/or update component 124 may be configured to utilize artificial intelligence, machine learning, and/or generative AI to perform functionalities described herein. For instance, the pattern component 118 may be configured to utilize the model(s) to decode data packet(s) and/or identify inconsistencies between first data and second data, identify inconsistencies in mappings, and/or identify inconsistencies used in security certificates.

In some examples, the artificial intelligence models are pre-trained using machine learning techniques. In some examples, the detection system 116 and/or firewall service 128 may store machine-trained data models for use during operation. Machine learning techniques include, but are not limited to supervised learning algorithms (e.g., artificial neural networks, Bayesian statistics, support vector machines, decision trees, classifiers, k-nearest neighbor, etc.), regression models, unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs.

Machine learning techniques include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. As used herein, the terms “machine learning,” “machine-trained,” and their equivalents, may refer to a computing model that can be optimized to accurately recreate certain outputs based on certain inputs. In some examples, the machine learning models include deep learning models, such as convolutional neural networks (CNN), deep learning neural networks (DNN), and/or artificial intelligence models. The term “neural network,” and its equivalents, may refer to a model with multiple hidden layers, wherein the model receives an input (e.g., a vector) and transforms the input by performing operations via the hidden layers. An individual hidden layer may include multiple “neurons,” each of which may be disconnected from other neurons in the layer. An individual neuron within a particular layer may be connected to multiple (e.g., all) of the neurons in the previous layer. A neural network may further include at least one fully-connected layer that receives a feature map output by the hidden layers and transforms the feature map into the output of the neural network. In some examples, the neural network comprises a graph where each node of the graph represents a layer within the neural network. Each node may be connected as part of a chain (e.g., a concatenation of layers). In some examples, input may be received by a node within the graph, the input is computed by the node and gets passed to one or more additional nodes in the chain.

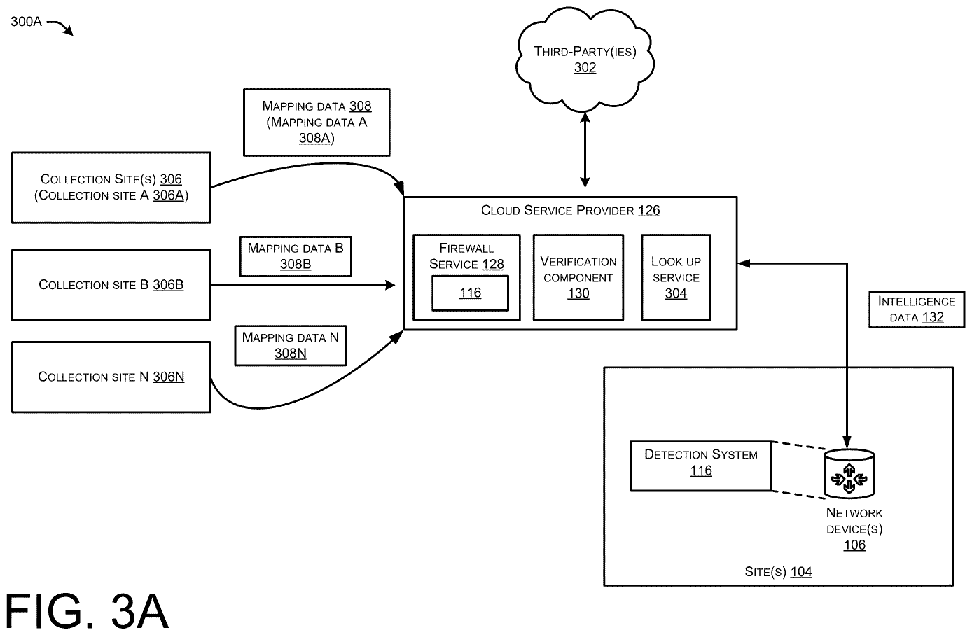

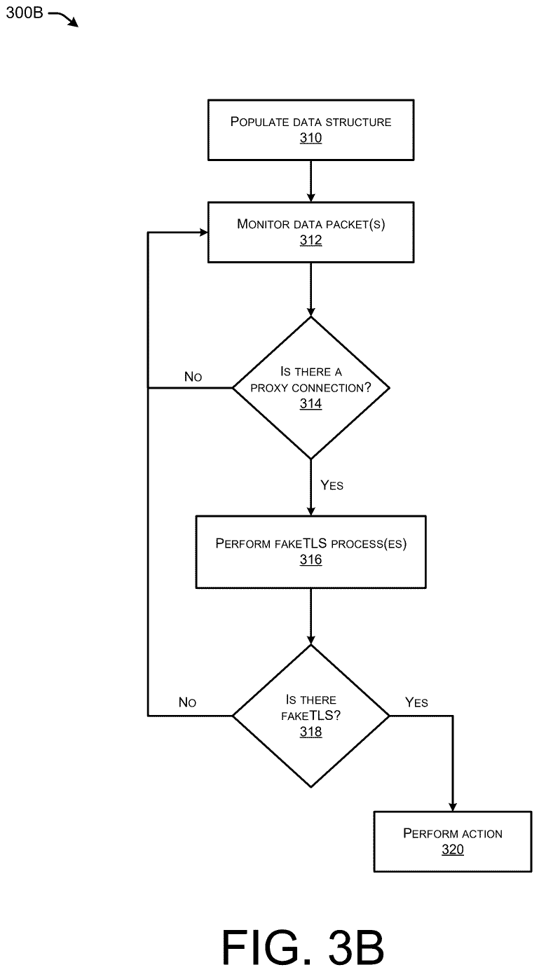

In some examples, the models may be updated and/or re-trained in real-time. For instance, the intelligence component 122 may update the one or more machine learning models based on intelligence data 132, mapping data (described in FIG. 3A below), outputs from the machine learning models, input from a network administrator, etc.

In some examples, the detection system 116 may comprise verification component 130. As described herein, the verification component 130 may be included as part of the detection system 116 that is implemented by a cloud service provider 126. The verification component 130 may be configured to process data collected from the plurality of collection sites and filter out mappings associated with proxy connections. As noted above, proxy connections may cause false positives to occur when identifying protocol impersonation. For instance, where the system monitors a live connection, data packet(s) received by the system that are not the client_hello and/or server_hello may appear as FakeTLS, even where the connection is valid. Accordingly, the verification component 130 may be configured to filter out data packet(s) associated with connection(s) that are live and include the use of a proxy. Accordingly, the mappings generated by the proxy connections are not included in the mappings compiled by the detection system 116, thereby reducing the amount of false positives generated when the address component 120 utilizes the mappings to determine FakeTLS.

The detection system 116 may further include a data store 216, such as long-term storage, that stores communication libraries 218 for the different communication protocols that the detection system 116 is configured to use or perform. Additionally, the data store 216 may include network topology data 220, such as a model representing the layout of the network components in the network 102 and/or data indicating available bandwidth, available CPU, delay between nodes, computing capacity, processor architecture, processor type(s), etc. The data store 216 may store policies 222 that include security data associated with the network, security policies configured for the network, firewall policies, intrusion prevention policies, firewall configuration data, network configuration policies, network configuration data, security posture data, and/or compliance policies configured for the network. The data store 216 may store data 224 including metadata, extension data, cipher suite data, intelligence data, mapping data, registry data, identifiers, device data, connection data, NetBIOS data, device information, fingerprint(s), hardware data, patterns, network data, keys, protocol data, network map data, pattern matching algorithms, or any other data and/or information described herein.

FIG. 3A illustrates an example system 300A for leveraging global infrastructure, according to the techniques described herein. In some instances, one or more of the steps of system 300A may be performed by one or more devices (e.g., detection system 116, cloud service provider 126, etc.) that include one or more processors and one or more non-transitory computer-readable media storing computer-executable instructions that, when executed by the one or more processors, cause the one or more processors to perform operations of system 300A.

In some examples, the system 300A may correspond to an example process where the detection system 116 and/or cloud service provider 126 leverages a global infrastructure that passively collects and processes DNS responses to build a map between IP addresses and domain names. As illustrated, system 300A may include cloud service provider 126, site(s) 104, network device(s) 106, detection system 116, firewall service 128, verification component 130, and intelligence data 132.

The system 300A may include third-party(ies) 302. As illustrated, the cloud service provider 126 may be configured to communicate with the third-party(ies) 302 in order to access various data. For instance, third-party(ies) 302 may represent one or more official registries, such as IANA.

The system 300A may include collection site(s) 306, which may be configured to send mapping data 308 to the cloud service provider 126. For instance, collection site A 306A may send second mapping data A 308A, collection site B 306B may send second mapping data B 308B, and collection site N 306N may send third mapping data N 308N. Each collection site 306 may represent a DNS collection site. In some examples, the collection site(s) 306 represent a plurality of collection sites located at different geographical locations around the world and are configured to passively collect DNS data. For instance, the collection site(s) 306 may utilize a service of the cloud service provider (e.g., such as Cisco's Mercury) to monitor live traffic and parse DNS packets to pull out the mappings between what domain a client is requesting (e.g., such as “Google.com”) and a list of IP addresses one or more DNS resolvers at the collection site returns. In some examples, the collection site(s) 306 may include integration(s) with DNS resolver(s) (e.g., such as Umbrella, Cloudflair, or other DNS resolvers).

The collection site(s) 306 may send mapping data 308 to the cloud service provider 126. The mapping data 308 may comprise mapping(s) between IP address(es) and domain(s). The mapping data 308 may also be referred to as “collected data” herein. The collection site(s) 306 may be configured to send mapping data 308 in real-time and/or on a periodic basis (e.g., hourly, daily, etc.).

As described herein, the verification component 130 may be configured to vet the mapping data 308 collected from the collection site(s) 306 in order to filter out mappings associated with proxy connections and thereby reduce the number of false positives found by the detection system 116. For instance, the verification component 130 may utilize the process described in FIG. 3B below.

The system 300A may further comprise look up service 304, which may be included as a service of the cloud service provider 126. The look up service 304 may be configured to perform real-time look ups of domain name(s) and/or address(es) received from a network device. For instance, a particular server name may be associated with evasive software but not included in the intelligence data 132 sent to network device(s) 106. In this example, the address component 120 of the network device(s) 106 may, in real-time, send a request to the look up service 304 to determine whether a particular IP address and/or domain is FakeTLS. The look up service 304 may, in response to the request, perform a fast lookup in a database of the detection system 116 to determine whether the database includes a mapping of the IP address and/or domain. Where a match is found, the look up service 304 may send a response indicating the IP address and/or domain are FakeTLS. Where there is not a match, the look up service 304 may indicate that no match was found.

FIG. 3B illustrates an example process 300B for vetting the mapping data collected by the system 300A of FIG. 3A. For instance, the process 300B may be implemented and/or performed by verification component 130. In some examples, the process 300B may be performed at collection site(s) 306, network device(s) 106, and/or cloud service provider 126.

At 310, the verification component 130 may populate a data structure. For instance, the verification component 130 may populate a data structure with intelligence data 132 and/or indications of whether domain(s) and/or addresses are associated with evasive techniques. In some examples, the data structure may be configured to enable fast look ups. For instance, the data structure may comprise an LC-trie data structure, or any other suitable data structure.

At 312, the verification component 130 may monitor data packet(s). In some examples, the data packet(s) comprise live packet(s) on the wire. For instance, the verification component 130 may be implemented at collection site(s) 306. In some examples, the verification component 130 may be configured to determine whether the data packet(s) comprise a TLS client_hello data packet.

At 314, the verification component 130 may determine whether the data packet(s) are associated with a proxy connection. For instance, the verification component 130 may utilize first data described herein to identify use of a proxy by either the client device(s) 108 and/or server(s) 110.

Where the verification component 130 determines there is a proxy connection (314-NO), the process returns to 312 and the verification component 130 continues monitoring data packet(s) from the collection site(s) 306 and/or on the wire.

Where the verification component 130 determines there is a proxy connection (314-YES), the process proceeds to 316. At 316, the verification component 130 may perform FakeTLS process(es). For instance, the verification component 130 may perform the process(es) of address component 120. As an example, the verification component 130 may retrieve, from the data structure and using the IP address included in the first data as in input, an expected domain name.

At 318, the verification component 130 may determine whether there is FakeTLS. For instance, the verification component 130 may determine there is FakeTLS where the value of the “server_name” field included in the first data does not match the expected domain name retrieved at 316. The verification component 130 may determine there is not FakeTLS (e.g., the connection is a valid TLS connection) where the value of the “server_name” field included in the first data matches the expected domain name retrieved at 316.

Where the verification component 130 determines there is not FakeTLS (318—NO), the process returns to 312 and the verification component 130 continues monitoring data packet(s) from the collection site(s) 306 and/or on the wire.

Where the verification component 130 determines there is FakeTLS (318—YES), the process proceeds to 320. At 320, the verification component 130 performs an action. For instance, the verification component 130 may generate a message indicating the IP address and domain mapping are associated with FakeTLS and output the message to the detection system 116 for use by the intelligence component 122 and/or action component 124. In some examples, the IP address and domain mapping may be included as part of mapping data 308.

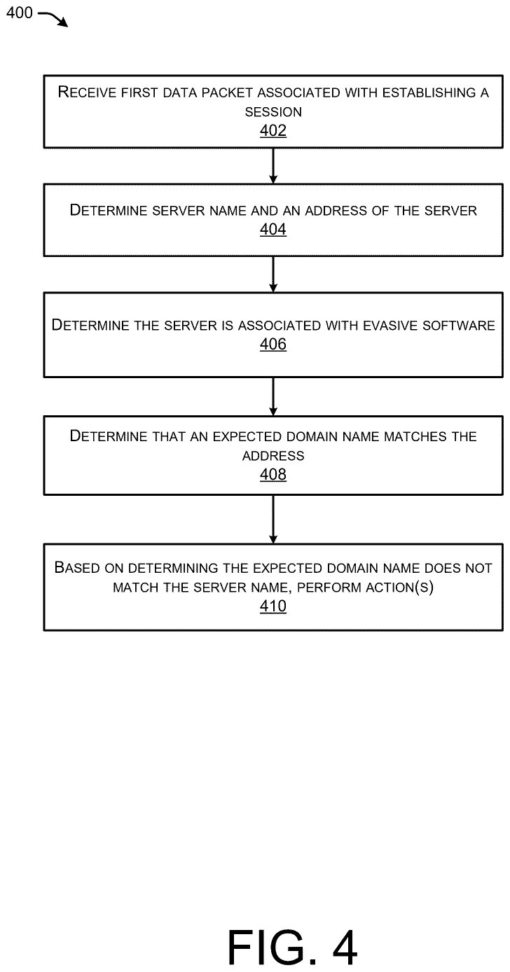

FIG. 4 illustrates a flow diagram of an example system 400 for detecting protocol impersonation and domain faking, according to the techniques described herein. In some instances, one or more of the steps of system 400 may be performed by one or more devices (e.g., detection system 116, network device(s) 106, address component 120, etc.) that include one or more processors and one or more non-transitory computer-readable media storing computer-executable instructions that, when executed by the one or more processors, cause the one or more processors to perform operations of system 400.

At 402, the system may receive a first data packet associated with establishing a session. For instance, the first data packet may be received from a client device. The first data packet may be associated with establishing a session between the client device and a server. In some examples, the session may comprise establishing a connection, such as a TLS session or other encrypted connection. In some examples, the first data packet may comprise a TLS client_hello data packet. The first data packet may comprise data including a server name, an address (e.g., destination address), cipher suite data, extension data, etc.

At 404, the system may determine a server name and an address of the server. For instance, the system may determine the server name and address based on the data included in the field(s) of the first data packet. The server name may be included as part of a “server_name” extension field of the TLS client_hello. In some examples, the address may correspond to an IP address associated with the destination of the first data packet (e.g., the destination IP address).

At 406, the system may determine the server is associated with evasive software. In some examples, the evasive software may be associated with supporting protocol impersonation or domain faking. For instance, in response to receiving the first data packet, the system may determine whether the system has collected or received intelligence data 132 indicating the server name is associated with protocol impersonation or domain faking. Where the system identifies intelligence data associated with the server name (e.g., indicating the system does have intelligence data associated with the server name), the system may proceed to 408. Where the system determines there is no intelligence data associated with the server name, the system may determine the first data packet is a valid TLS client_hello and may exit the process.

In some examples, determining that the server name is associated with evasive software that supports protocol impersonation or domain faking comprises: performing, based on accessing a database, a longest prefix match lookup of the server name; in response to performing the longest prefix match lookup, receiving an indication that the server name matches a value stored in the database, the expected domain name, and a set of addresses associated with the expected domain name.

At 408, the system may determine that an expected domain name matches the address. For instance, the system may perform a longest-prefix match algorithm on the destination address to determine whether there are subnet(s) associated with the address. As an example, where the system is implemented by a network device, the system may perform the look up in order to receive the expected domain name associated with the IP address. The system may perform the look up as a fast look up using the LC-trie data structure.

At 410, the system may, based on determining that the expected domain name does not match the server name, perform action(s). In some examples, the action comprises one or more of generating an alert or blocking a connection associated with the session. In some examples, the action may comprise generating an attribute indicating the server is running evasive software; and updating a network map to include the attribute in association with the server.

In some examples, the system may be implemented by one or more of a cloud service (e.g., such as a firewall service 128) implemented by a cloud service provider 126. In some examples, the system may be implemented by a firewall service 128 executing on a network device 106.

In some examples, the system may collect, from a plurality of domain name system (DNS) resolvers monitoring traffic at a plurality of locations, mappings between domains and internet protocol (IP) subnets. The system may determine a subset of the mappings associated with protocol impersonation or domain faking. The system may generate, based on the subset of the mappings, a watch list comprising one or more mapping of the subset of the mappings, wherein each mapping comprises one or more subnet addresses and an associated expected domain name. In some examples, the system may send the watch list (e.g., as intelligence data 132) to one or more network devices. The network device(s) may compile the watch list into a fast lookup format. For instance, the network device(s) may compile the watch list such that it can be loaded into a data structure for fast lookups. The network device(s) may store the watch list in the fast lookup format in data structures of the one or more network devices.

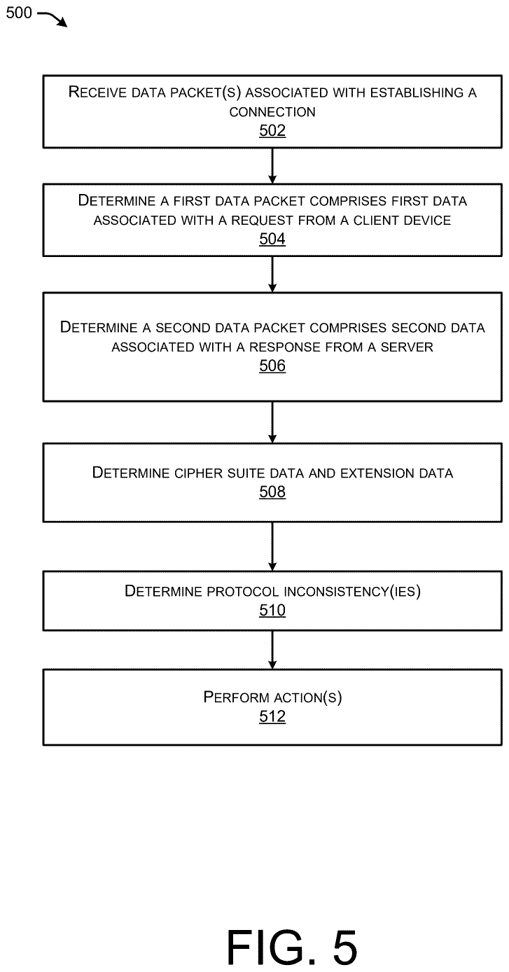

FIG. 5 illustrates a flow diagram of an example system 500 for detecting protocol impersonation, according to the techniques described herein. In some instances, one or more of the steps of system 500 may be performed by one or more devices (e.g., detection system 116, network device(s) 106, pattern component 118, etc.) that include one or more processors and one or more non-transitory computer-readable media storing computer-executable instructions that, when executed by the one or more processors, cause the one or more processors to perform operations of system 500.

At 502, the system may receive data packet(s) associated with establishing a connection. For instance, the system may receive a first data packet from a client device associated with establishing a connection (e.g., such as a TLS session) with a server. The system may receive a second data packet from the server association with establishing the connection with the client device. In some examples, the data packet(s) may correspond to a TLS handshake. In some examples, the system may passively monitor the data packet(s).

At 504, the system may determine a first data packet comprises first data associated with a request from a client device. For instance, the system may determine the first data packet comprises first data corresponding to a transport layer security (TLS) client_hello data packet. The first data may comprise cipher suit data, extension data, IP address(es), server name(s), etc.

At 506, the system may determine a second data packet comprises second data associated with a response from a server. For instance, the system may determine the second data packet comprises a TLS server_hello packet. The second data may comprise selected cipher suite data and second extension data associated with establishing the connection.

At 508, the system may determine cipher suite data and extension data. For instance, the system may determine, based on the first data, cipher suite data and extension data associated with the client device.

At 510, the system may determine protocol inconsistency(ies). For instance, the system may determine one or more protocol inconsistency(ies) based on one or more of the cipher suite data, the extension data, and the second data. The system may determine the protocol inconsistency(ies) using pattern component 118. In some examples, the one or more protocol inconsistencies comprise determining that: a threshold number of cipher suites indicated in the cipher suite data are not recognized by an internet assigned numbers authority (IANA); a selected cipher suite indicated in the second data does not match any cipher suite included in the cipher suite data; the extension data is not recognized by IANA; the second data does not include the extension data; one or more parameters included in the extension data does not match one or more second parameters included in second extension data included in the second data packet; a timestamp included in the first data packet or the second data packet is not accurate; or a nonce value included in the first data packet or the second data packet is not accurate.

At 512, the system may perform action(s). For instance, the action may comprise one or more of generating an alert or blocking a connection associated with the session. The action may comprise generating an attribute indicating the server is running evasive software; and updating a network map to include the attribute in association with the server. In some examples, the action may comprise storing, in a cache memory, a mapping between an address of the server and a server name, the mapping indicating the address and the server name are associated with protocol impersonation; and updating, based on the cache memory, a watch list (e.g., intelligence data 132) to include the mapping.

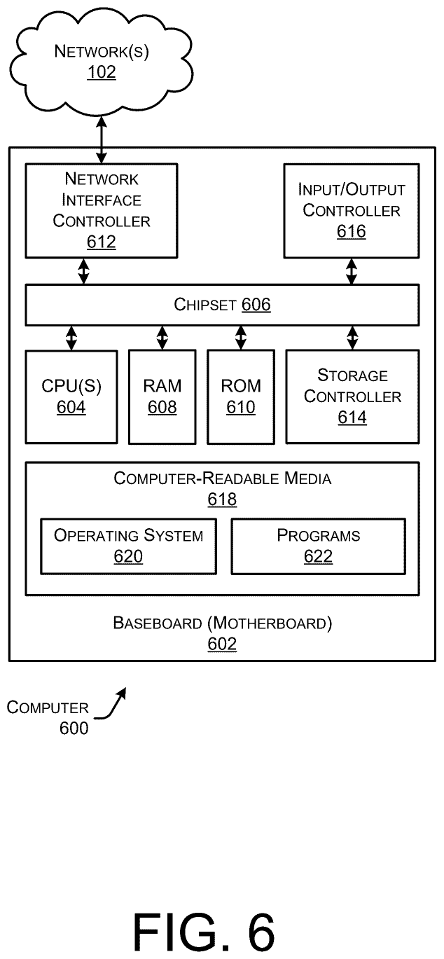

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a detection system 116 and/or any other device described herein, and may comprise personal devices (e.g., smartphones, tables, wearable devices, laptop devices, etc.), networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as network 102. The chipset 606 can include functionality for providing network connectivity through a NIC 612, such as a gigabit Ethernet adapter. The NIC 612 is capable of connecting the computer 600 to other computing devices over the network 102. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the detection system 116 and/or any components included therein, may be supported by one or more devices similar to computer 600. Stated otherwise, some or all of the operations performed by the detection system 116 and/or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of a detection system 116 and/or any other device. The computer 600 may include one or more hardware processors (e.g., processors such as CPUs 604) configured to execute one or more stored instructions. The processor(s) may comprise one or more cores. Further, the computer 600 may include one or more network interfaces configured to provide communications between the computer 600 and other devices, such as the communications described herein as being performed by the detection system 116 and/or any other device. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure. For instance, the programs 622 may cause the computer 600 to perform techniques including receiving, from a client device, a first data packet associated with establishing a session between the client device and a server; determining, based on data included in the first data packet, a server name and an address of the server; determining that the server name is associated with evasive software that supports protocol impersonation or domain faking; determining that an expected domain name matches the address; and based on determining that the expected domain name does not match the server name, performing an action.

The programs 622 may also cause the computer 600 to perform techniques including receiving a first data packet and a second data packet associated with establishing a connection between a client device and a server; determining that the first data packet comprises first data associated with a request from the client device; determining that the second data packet comprises second data associated with a response from the server; determining, based on the first data, cipher suite data and extension data associated with the client device; determining, based on the cipher suite data, the extension data, and the second data, one or more protocol inconsistencies; and performing, based on the one or more protocol inconsistencies, an action.

In this way, the computer 600 may provide an intelligent way to enforce network policies and detect protocol impersonation before a session is established. By utilizing and mapping IP addresses of the “good” (e.g., valid) services associated with a domain, the techniques described herein are more stable and reliable. For instance, the techniques described herein may be applied to TLS client_hello packets in a passive manner, reducing resources required by the system (e.g., in contrast, with decryption, were you have to actively establish connection, which is computationally more intensive). Further, by utilizing the global infrastructure to identify and map IP addresses to the domain(s), the techniques described herein provide improved accuracy at identifying protocol impersonation and provide fewer false positives than existing techniques. Thus, the techniques may improve network security by preventing evasive techniques from bypassing network enforcement tools within a network.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method of detecting protocol impersonation and domain faking, the method comprising:
receiving, from a client device, a first data packet associated with establishing a session between the client device and a server;
determining, based on data included in the first data packet, a server name and an address of the server;
determining that the server name is associated with evasive software that supports protocol impersonation or domain faking;
determining that an expected domain name matches the address; and
based on determining that the expected domain name does not match the server name, performing an action.

2. The method of claim 1, further comprising:
collecting, from a plurality of domain name system (DNS) resolvers monitoring traffic at a plurality of locations, mappings between domains and internet protocol (IP) subnets;
determining a subset of the mappings associated with protocol impersonation or domain faking; and
generating, based on the subset of the mappings, a watch list comprising one or more mapping of the subset of the mappings, wherein each mapping comprises one or more subnet addresses and an associated expected domain name.

3. The method of claim 2, further comprising:
sending the watch list to one or more network devices;
compiling, by the one or more network devices, the watch list into a fast lookup format; and
storing the watch list in the fast lookup format in data structures of the one or more network devices.

4. The method of claim 2, wherein determining that the server name is associated with evasive software that supports protocol impersonation or domain faking comprises:
performing, based on accessing a database, a longest prefix match lookup of the server name; and
in response to performing the longest prefix match lookup, receiving an indication that the server name matches a value stored in the database, the expected domain name, and a set of addresses associated with the expected domain name.

5. The method of claim 1, wherein the action comprises one or more of generating an alert or blocking a connection from forming.

6. The method of claim 5, wherein the action further comprises:
generating an attribute indicating the server is running evasive software; and
updating a network map to include the attribute in association with the server.

7. The method of claim 1, wherein the method is implemented by firewall service executing at a cloud service provider or on a network device.

8. A system comprising:
one or more processors; and
one or more computer-readable media storing instructions that, when executed by the one or more processors, cause the one or more processors to perform operations comprising:
receiving, from a client device, a first data packet associated with establishing a session between the client device and a server;
determining, based on data included in the first data packet, a server name and an address of the server;
determining that the server name is associated with evasive software that supports protocol impersonation or domain faking;
determining that an expected domain name matches the address; and
based on determining that the expected domain name does not match the server name, performing an action.

9. The system of claim 8, the operations further comprising:
collecting, from a plurality of domain name system (DNS) resolvers monitoring traffic at a plurality of locations, mappings between domains and internet protocol (IP) subnets;
determining a subset of the mappings associated with protocol impersonation or domain faking; and
generating, based on the subset of the mappings, a watch list comprising one or more mapping of the subset of the mappings, wherein each mapping comprises one or more subnet addresses and an associated expected domain name.

10. The system of claim 9, the operations further comprising:
sending the watch list to one or more network devices;
compiling, by the one or more network devices, the watch list into a fast lookup format; and
storing the watch list in the fast lookup format in data structures of the one or more network devices.

11. The system of claim 8, wherein determining that the server name is associated with evasive software that supports protocol impersonation or domain faking comprises:
performing, based on accessing a database, a longest prefix match lookup of the server name; and
in response to performing the longest prefix match lookup, receiving an indication that the server name matches a value stored in the database, the expected domain name, and a set of addresses associated with the expected domain name.

12. The system of claim 8, wherein the action comprises one or more of generating an alert or blocking a connection associated with the session.

13. The system of claim 8, wherein the action wherein the action comprises:
generating an attribute indicating the server is running evasive software; and
updating a network map to include the attribute in association with the server.

14. The system of claim 8, wherein the system is implemented by firewall service executing at a cloud service provider or on a network device.

15. A method of detecting protocol impersonation, comprising:
receiving a first data packet and a second data packet associated with establishing a connection between a client device and a server;
determining that the first data packet comprises first data associated with a request from the client device;
determining that the second data packet comprises second data associated with a response from the server;
determining, based on the first data, cipher suite data and extension data associated with the client device;
determining, based on the cipher suite data, the extension data, and the second data, one or more protocol inconsistencies; and
performing, based on the one or more protocol inconsistencies, an action.

16. The method of claim 15, further comprising:
storing, in a cache memory, a mapping between an address of the server and a server name, the mapping indicating the address and the server name are associated with protocol impersonation; and
updating, based on the cache memory, a watch list to include the mapping.

17. The method of claim 15, wherein the action comprises one or more of generating an alert or blocking the connection.

18. The method of claim 17, wherein the action further comprises:
generating an attribute indicating the server is running evasive software; and
updating a network map to include the attribute in association with the server.

19. The method of claim 15, wherein the first data packet comprises a transport layer security (TLS) client_hello packet and the second data packet comprises a TLS server_hello packet.

20. The method of claim 15, wherein the one or more protocol inconsistencies comprise determining that:
a threshold number of cipher suites indicated in the cipher suite data are not recognized by an internet assigned numbers authority (IANA);
a selected cipher suite indicated in the second data does not match any cipher suite included in the cipher suite data;
the extension data is not recognized by IANA;
the second data does not include the extension data;
one or more parameters included in the extension data does not match one or more second parameters included in second extension data included in the second data packet;
a timestamp included in the first data packet or the second data packet is not accurate; or
a nonce value included in the first data packet or the second data packet is not accurate.
